(19) United States
(12) Patent Application Publication
(10) Pub. No.: US 2014/0305405 A1
(43) Pub. Date: Oct. 16, 2014

(54) METHOD FOR ASSEMBLING AN AIR CONTROL VALVE

(71) Applicant: Valeo Systemes de Controle Moteur, Gergy Saint Christophe (FR)

(72) Inventors: Emmanuel Felix, Jouy Le Moutier (FR); Jérôme Blanchard, Bleury (FR); Adrien Soto, Laval (FR)

(21) Appl. No.: 14/360,720

(22) PCT Filed: Nov. 16, 2012
(86) PCT No.: PCT/FR2012/052646

§ 371 Date: May 27, 2014

(30) Foreign Application Priority Data
Nov. 28, 2011 (FR) 1160861

(51) Int. Cl. F02D 9/10; F02M 25/07

(52) U.S. Cl. CPC F02D 9/10; F02M 25/0714; F02M 25/0787
USPC 123/337; 137/15.18; 123/568.19

(57) ABSTRACT

The invention relates to a method for assembling a regulation valve (10) intended for controlling the flow of gas in a circuit of a motor vehicle equipped with a heat engine, said valve (10) comprising a magnetic structure (15), a rotation axis (21) and a toothed section (16). The main feature of an assembly method according to the invention is that it comprises the following steps:—mouthing of the toothed section (16) on the rotation axis (21),—rigid connection by welding the magnetic structure (15) to the toothed section (16) fixed to the rotation axis (21).

The invention relates to a method for assembling a control valve permitting the passage of gas in a gas circuit of an automotive vehicle to be regulated.

An automotive vehicle provided with a heat engine generally comprises an air cooling circuit in addition to at least one EGR (Exhaust Gas Recirculation) loop making it possible to extract exhaust gases and redirect them upstream of the engine so that they are mixed with the incident air. Said different gas circuits are regulated by means of valves which are able to adopt different configurations, passing from a completely closed position to a maximum open position, passing through intermediate open positions. The invention relates to an optimized method for assembling a valve for regulating gas in addition to a valve based on such a method.

It is noteworthy that the term “valve” is general and denotes any type of device for regulating gas within a gas circuit of an automotive vehicle. Such a valve may, for example, be an air intake metering device or a regulating valve of an EGR loop.

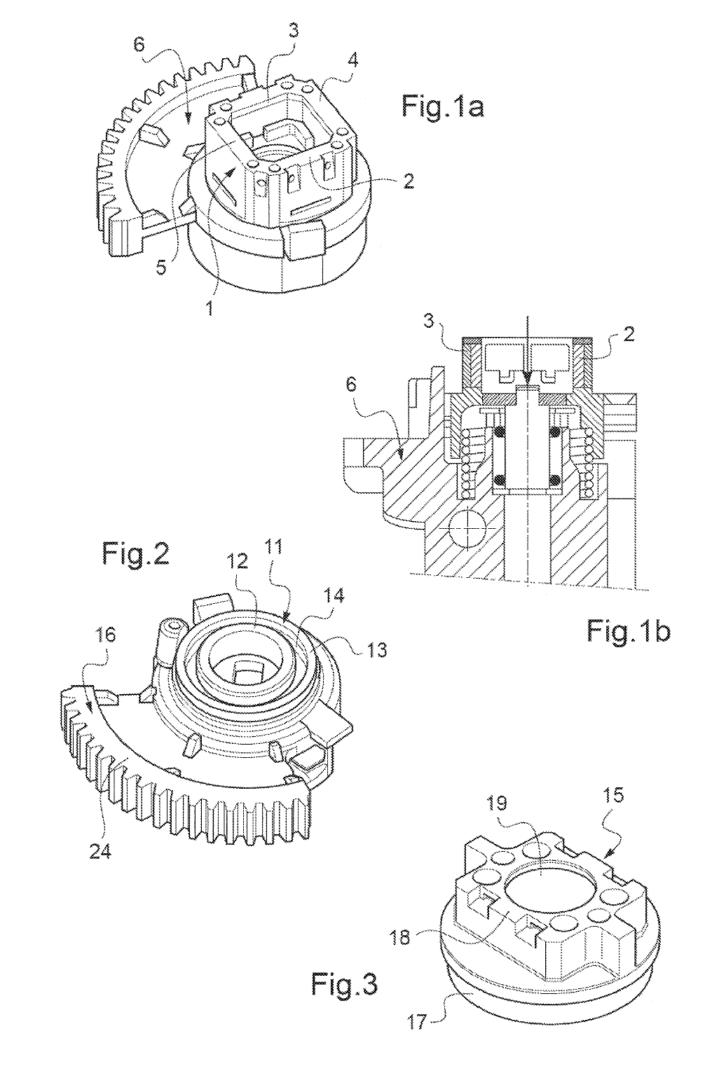

With reference to FIGS. 1a and 1b, a valve of the prior art designed to regulate a flow of gas operates with a magnetic structure 1 and a Hall effect sensor. This magnetic structure comprises two magnets 2, 3 and two poles 4, 5 arranged in a square configuration, said structure 1 being overmolded on a toothed sector 6 forming a quarter of a circle. This arrangement in which the structure 1 emerges from the toothed sector 6 takes up a significant volume which is not compatible with the restricted space left available below the hood of a vehicle, around the engine.

A method for assembling according to the invention makes it possible to produce gas control valves having a reduced space requirement by promoting the positioning of planar magnets which requires much less space than a square-shaped protruding configuration. This novel arrangement of the magnets is made possible due to an original connecting technique permitting two elements to be fixed together, the specific geometries thereof making this fixing difficult by means of the usual methods.

The subject of the invention is a method for assembling a regulating valve designed to control the flow of gas in a circuit of an automotive vehicle provided with a heat engine, said valve comprising a magnetic structure, a pivot pin and a toothed sector.

The method according to the invention comprises the following steps:
assembling the toothed sector on the pivot pin,
fixing by welding the magnetic structure to the toothed sector which is fixed to the pivot pin.

Thus the position of the toothed sector is firstly fixed to the pivot pin, then the magnetic structure is brought into contact with said sector in order to be fixed thereto by means of a weld. Said two steps are simple to carry out and thus rapid to implement, the welding technique being more secure and reliable to connect two elements rigidly together. Moreover, this technique of connecting by welding does not require the presence of interface components or mechanical fixing means such as screws and permits two elements to be connected together whilst saving space.

Advantageously, the toothed sector comprises an annular groove and the magnetic structure comprises a circular protruding edge, the fixing step being implemented by rotational welding carried out between said edge and the bottom of said groove. In other words, the insertion of the edge in the groove permits a prepositioning of the magnetic structure on the toothed sector before said structure is fixed definitively in said sector by welding. Such an assembly, involving an implicit guide step, contributes to a satisfactory arrangement of the components relative to one another, without the risk of poor positioning before welding. Moreover, the penetration of the edge in the groove lowers the position of the magnetic structure on the toothed sector by a height substantially equivalent to the depth of said groove, thus limiting the space taken up by said structure on said toothed sector. Rotational welding is particularly suited to the annular contact interface between the magnetic structure and the toothed sector.

Preferably, the method comprises a step of installing a fixed Hall effect sensor in the valve, so that the magnetic structure is located between the toothed sector and said sensor. Said sensor is fixed in a given position within the valve and permits the magnetic field delivered by the pivoted magnetic structure to be measured and thus the intensity of said field to be varied in a given direction.

Advantageously, the method uses a prior step of overmolding the magnetic structure. Before being welded to the toothed sector, the magnetic structure will have been produced in a single piece by overmolding. Such a manufacturing step of a component made of plastics is simple and rapid to execute, contributing to simplifying even further the method for assembling according to the invention.

The subject of the invention is also a regulating valve designed to control the flow of gas in a circuit of an automotive vehicle provided with a heat engine. The principal feature of said valve is that it is manufactured from a method for assembling according to the invention. Such a valve may be encountered on any type of gas circuit circulating around the engine, said circuit able to be a cooling circuit of said engine or an EGR loop, for example. A valve manufactured by means of a method for assembling according to the invention has a reduced space requirement due to a compact arrangement of the components involved, which is made possible by the technique of rotational welding.

Advantageously, the magnetic structure comprises a hollow cylindrical base designed to be housed in an annular groove of the toothed sector, said circular base being surmounted by a square-shaped frame in which at least one magnet is placed. The frame defines a housing in which each magnet is placed, said frame also serving to protect each of said magnets from any external impact. It is assumed that the external diameter of the base is slightly less than that of the external circular wall of the groove. Each magnet is placed in the frame without introducing clearance so that it does not vibrate when the vehicle is in the traveling phase.

Preferably, the base and the frame are produced in a single piece by overmolding. According to a preferred embodiment of a valve according to the invention, the base and the frame are produced from plastics material.

Advantageously, each magnet has a frustoconical shape. This shape of magnet is easy to machine and well suited to the environment of the valve.

According to a first preferred embodiment of a valve according to the invention, said valve constitutes an air intake metering device. Generally, an air metering device is placed in an air cooling circuit of an engine, upstream of said engine and permits the incident flow of air arriving in the intake manifold to be regulated.

According to a second preferred embodiment of a valve according to the invention, said valve constitutes a valve controlling the flow of gas of an EGR loop. An air supply circuit permitting an engine to be cooled, generally comprises at least one EGR loop which makes it possible to extract exhaust gases to mix the exhaust gases with the incident air circulating upstream of said engine.

The methods for assembling according to the invention enable valves to be produced for regulating the flow of gas, said valves having a reduced space requirement and thus being particularly suitable for an air supply circuit designed to cool an engine of an automotive vehicle. They also have the advantage of implementing steps which are simple and rapid to execute, such as for example the manufacture of components by overmolding and the operation of rotational molding.

A detailed description of a preferred embodiment of a valve for regulating the flow of gas according to the invention is provided hereinafter with reference to FIGS. 1 to 5.

FIG. 1a is a perspective view of an assembly of a toothed sector and a magnetic structure of a valve of the prior art.

FIG. 1b is an axial sectional longitudinal view of the assembly of FIG. 1a,

FIG. 2 is a perspective view of a toothed sector of a valve according to the invention,

FIG. 3 is a perspective view of a magnetic structure of a valve according to the invention,

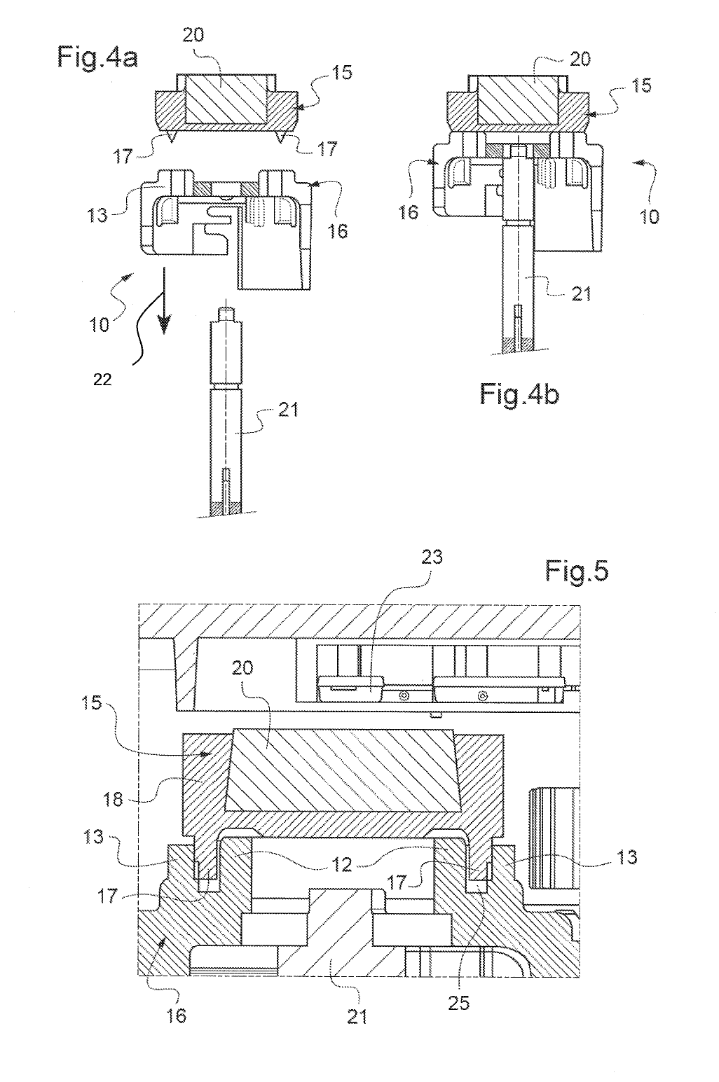

FIG. 4a is a sectional view of a pivot pin, a toothed sector and a magnetic structure of a valve according to the invention, before mounting.

FIG. 4b is a sectional view of a pivot pin, a toothed sector and a magnetic structure of a valve according to the invention, after assembly.

FIG. 5 is a sectional view of a toothed sector, a magnetic structure and a sensor of a valve according to the invention.

FIGS. 1a and 1b have already been described.

With reference to FIGS. 1 and 2, a valve according to the invention consists of an air intake metering device placed in the upstream part of an air cooling circuit of an engine of an automotive vehicle. Said metering device 10 makes it possible to regulate the flow of incident air which cools the engine, by adopting several configurations. More specifically, it may be controlled to interrupt said flow when the engine is sufficiently cooled. Said metering device may also authorize a maximum airflow when the vehicle runs at full speed and when the engine is at risk of being overheated. Finally, it may be adjusted into an intermediate position in order to permit the passage of a moderate air flow.

With reference to FIG. 2, the metering device 10 schematically comprises a toothed sector 16 comprising a circular-arc toothed segment 24 which substantially covers a quarter of a circle, and a projection 11 emerging beyond said toothed sector 16 and composed of two hollow cylindrical components 12, 13, arranged in a concentric manner. The toothed sector 16 and the projection 11 comprising the two cylindrical components 12, 13 are produced in a single piece by overmolding. The two cylindrical components 12, 13 create a free space 14 therebetween defining an annular groove.

With reference to FIG. 3, the metering device 10 comprises a magnetic structure 15 provided with a hollow cylindrical base 17 and overmolded by a frame 18 of substantially rectangular shape. Said frame 18 defines an internal space 19 having a frustoconical geometry and designed to house a frustoconical magnet 20 as FIG. 5 shows. The dimensions of said magnet 20 are slightly smaller than those of its housing 19 to the extent that it is inserted inside said housing without leaving any clearance. In this manner, the magnet 20 remains fixed inside the frame 18 and is thus not able to vibrate inside said frame. The base 17 and the frame 18 are preferably produced in a single piece by overmolding.

With reference to FIGS. 4a and 4b, the air intake metering device 10 also has a pivot pin 21, to which a flap is fixed, not visible in the figures, said flap being located in the air intake duct of the engine in order to regulate the incident airflow. More specifically, the toothed sector 16 of the metering device 10 is pivoted under the action of a complementary toothed sector in contact therewith and connected to a control unit, this rotation causing the rotation of the flap to regulate the flow of air in the duct. A method for assembling according to the invention permitting the manufacture of a metering device 10 comprises the following steps:
the toothed sector 16 is inserted around the pivot pin 21 as the arrow 22 indicates, then its definitive position about said axis 21 is fixed rigidly,
the magnetic structure 15 is then brought into contact with the toothed sector 16 placed around the axis 21, so that the base 17 penetrates the annular groove 14,
with reference to FIGS. 4b and 5, the magnetic structure 15 is fixed to the toothed sector 16 by a rotational weld carried out between the base 17 and the bottom of the said groove 14, by means of a small weld 25 interposed between the free end of said base 17 and the bottom of said groove 14.

With reference to FIG. 5, a Hall effect sensor 23 is placed fixedly in the metering device 10 in the vicinity of the magnet 20 housed in the frame 18 of the magnetic structure 15, said magnet 20 being positioned between said fixed sensor 23 and the rotational toothed sector 16. The Hall effect sensor which makes it possible to measure the magnetic field produced by the magnetic structure 15 is an indicator of the degree of opening of the flap of the metering device 10 in the air circuit.

The operation of the metering device 10 is as follows. A signal is transmitted to an energy source controlling the rotation of the complementary toothed sector, which then initiates a controlled pivoting movement, driving the pivoting of the toothed sector 26 of the metering device 10 by the meshing thereof. The rotation of said toothed sector 26 simultaneously causes the rotation of the magnetic structure 15 which is fixed thereto, in addition to that of the flap. The Hall effect sensor 23 which remains fixed in the metering device 10, thus measures the magnetic field produced by the magnetic structure 15 after the pivoting thereof. Due to this sensor 23, the position of the flap in the cooling circuit is thus known.

1. A method for assembling a regulating valve designed to control the flow of gas in a circuit of an automotive vehicle provided with a heat engine, said valve comprising a magnetic structure, a pivot pin and a toothed sector, the method comprising:
assembling the toothed sector on the pivot pin; and
fixing by welding the magnetic structure to the toothed sector which is fixed to the pivot pin.

2. The method for assembling as claimed in claim 1, wherein the toothed sector comprises an annular groove and in that the magnetic structure comprises a circular protruding edge, the fixing step being implemented by rotational welding carried out between said edge and the bottom of said groove.

3. The method for assembling as claimed in claim 1, further comprising a step of installing a fixed Hall effect sensor in the valve, so that the magnetic structure is located between the toothed sector and said sensor.

4. The method for assembling as claimed in claim 1, further comprising a prior step of overmolding the magnetic structure.

5. A regulating valve designed to control the flow of gas in a circuit of an automotive vehicle provided with a heat engine, wherein the valve is assembled using a method as claimed in claim 1.

6. The regulating valve as claimed in claim 5, wherein the magnetic structure comprises a hollow cylindrical base designed to be housed in an annular groove of the toothed sector and in that wherein said circular base is surmounted by a square-shape frame in which at least one magnet is placed.

7. The regulating valve as claimed in claim 6, wherein the base and the frame are produced in a single piece by overmolding.

8. The regulating valve as claimed in claim 6, wherein each magnet has a frustoconical shape.

9. The regulating valve as claimed in claim 5, wherein the valve constitutes an air intake metering device.

10. The regulating valve as claimed in claim 5, wherein the valve controls the flow of gas of an EGR loop.
